(19) United States
(12) Patent Application Publication
(10) Pub. No.: US 2007/0220884 A1
(43) Pub. Date: Sep. 27, 2007

(54) Divided housing turbocharger for an engine

(76) Inventors: Patrick W. Savage JR., Chillicothe, IL (US); Christopher R. Gehrke, Chillicothe, IL (US); James H. Mutti JR., East Peoria, IL (US); David M. Costura, Lincolnshire (GB); Joshua D. Keyes, East Peoria, IL (US); Steven J. Funke, Mapleton, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/646,399

(22) Filed: Dec. 28, 2006

Related U.S. Application Data
(63) Continuation-in-part of application No. 10/998,739, filed on Nov. 30, 2004.

(51) Int. Cl. F02D 23/00

(52) U.S. Cl. 60/602

(57) ABSTRACT

A turbocharger for an engine is provided. The turbocharger has a turbine and a housing enclosing the turbine. The housing has a first annular passageway and a second annular passageway. Both of the first and second annular passageways extend to the turbine. The turbocharger also has a valve mechanism disposed within an inlet of the housing. The valve mechanism has a valve element pivotally attached to a portion of the housing. The valve element is movable between a first position at which exhaust flow through the first annular passageway is blocked and a second position at which exhaust flows through both of the first and second annular passageways. A controller controls positioning of the valve element based on a sensed operational parameter of the engine and also controls functions of the engine.

This application is a continuation-in-part of U.S. patent application Ser. No. 10/998,739, filed Nov. 30, 2004.

### TECHNICAL FIELD

The present disclosure is directed to a divided housing turbocharger and, more particularly, to a divided housing turbocharger with a variable nozzle area.

### BACKGROUND

Internal combustion engines such as, for example, diesel engines, gasoline engines, or natural gas engines may be operated to generate a power output. In order to maximize the power generated by the internal combustion engine, the engine may be equipped with a turbocharged air induction system.

A turbocharged air induction system may include a turbocharger that compresses the air flowing into the engine to thereby force more air into a combustion chamber of the engine than possible with a naturally-aspirated engine. The turbocharger is typically matched to perform efficiently when the engine is operating within a particular performance range (i.e., rated load and speed). When the engine operates outside of the particular performance range, the efficiency of the turbocharger may drop and the turbocharger could possibly malfunction. For example, when operating at low load and speed, the turbocharger may provide insufficient air for optimal combustion. Conversely, when the engine is operating at high load and speed, the turbocharger may tend to exceed a maximum allowable rotational speed.

One method of improving turbocharger efficiency and function throughout a range of engine operating conditions is to employ a variable nozzle area device. One such device is described in U.S. Pat. No. 3,557,549 issued to Webster et al. on Jan. 26, 1971. The '549 patent to Webster et al. describes a turbine having separate compartments and a flapper valve pivotally mounted to an inlet of the turbine. The flapper valve remains at a neutral position during periods of high engine speed and load and moves to a closed position at which it blocks exhaust flow into one of the separated compartments to divert all of the engine exhaust flow into the other of the separated compartments. By diverting all of the exhaust flow to only one of the separated compartments the velocity of the exhaust flow through that compartment increases, thereby resulting in increased turbine rotational speed. The higher turbine rotational speeds force more air into the engine, thereby improving combustion at low engine loads and speeds. The flapper valve of the '549 patent allows the turbocharger to be matched for efficient operation at high load and speed by opening both of the separated compartments, yet still provides sufficient air at low load and speed by selectively closing one of the separated compartments.

Although the flapper valve of the '549 patent may improve turbine efficiency and provide adequate air, it may not seal sufficiently. In particular, because the flapper valve of the '549 patent does not close against a valve seat, exhaust may leak past the flapper valve and reduce its effectiveness. Further, the shape of the flapper valve may restrict exhaust flow through the one of the separated compartments that is selectively blocked, while the opening swing direction of the flapper valve may make it difficult to unseat the flapper valve. In addition, the flapper valve of the '549 patent may deteriorate prematurely. In particular, the flapper valve of the '549 patent is always fully exposed to the degrading effects of the exhaust flow, regardless of the position of the flapper valve.

Other considerations and engine configurations may be implemented to improve overall system efficiency. For example, energy recovery capabilities, overall efficiency, and increased engine flexibility may be achieved by employing additional features such as Miller Cycle operation, multiple stage pressurization of intake air, and variable valve timing, for example.

U.S. Pat. No. 3,257,797 issued to Lieberherr on Jun. 28, 1966 discloses, in FIG. 1 thereof, an engine including at least two stages of turbocharging (20, 16) with a first cooling stage (22) between the compressor units of the two turbochargers and a second cooling stage (24) between the second compressor unit and the engine. Along with this, Lieberherr discloses a variable intake valve closing system and, while not using the term “Miller Cycle,” Lieberherr discloses using variable valve timing to close the inlet valve early, during the suction (i.e., intake) stroke of the piston, or late, during the compression stroke of the piston (which maintains the intake valve open for a portion of the compression stroke), in order to reduce the effective compression ratio (col. 6, lines 57-63). Additionally, Lieberherr discloses that reducing the effective compression ratio occurs with increasing engine load (col. 10, lines 17-24).

While the disclosure of the Lieberherr patent recognizes a number of important expedients, such as, dual stage turbocharging, late intake valve closing to maintain the intake valve open for a portion of the compression stroke to yield a reduced effective compression ratio at high engine loads, and variable valve timing, Leiberherr does not recognize the advantages of particular turbocharger arrangements.

U.S. Pat. No. 2,670,595 issued to Miller on Mar. 2, 1954. The Miller '595 patent in FIG. 6, for example, discloses an engine including a turbocharger (52, 55) for pressurizing intake air and a cooler (58) between the turbocharger and engine intake ports. Additionally, Miller '595 discloses a variable intake valve closing system (FIG. 6; col. 9, line 23 through col. 10, line 21), and discloses a specific example of closing the intake valve early during the intake stroke at about 60° after top dead center (e.g., col. 6, lines 64-69). Miller '595 also specifically discloses varying the effective compression ratio in consonance with load by holding the intake valve open during the entire intake stroke and during a part of the following compression stroke (col. 8, lines 14-23) (i.e., late closing of the intake valve).

While the disclosure of Miller '595 recognizes a number of important expedients, such as, pressurizing and cooling the intake air, variable intake valve timing, and both very early intake valve closing and late intake valve closing to vary the effective compression ratio in consonance with load, Miller '595 does not discuss a divided housing turbocharger.

U.S. Pat. No. 3,015,934 issued to Miller on Jan. 9, 1962. The Miller '934 patent discloses, in FIG. 1 thereof, an engine including a turbocharger (28) for pressurizing intake air and a cooler (36) between the turbocharger and engine intake ports. Additionally, Miller '934 discloses a variable intake valve closing system (FIG. 2), and discloses a specific example of late closing of the intake valve during the compression stroke, at 60 or 70 degrees before top dead center (col. 2, lines 31-33), reducing the effective compression ratio.

While Miller '934 recognizes a number of important expedients, such as, pressurizing and cooling the intake air, variable valve timing, and maintaining the intake valve open during a majority portion of the compression stroke to as much as 60 or 70 degrees before top dead center in the compression stroke, Miller '934 does not discuss divided housing turbochargers.

Features set forth in the present disclosure may address one or more of the issues discussed above.

### SUMMARY OF THE INVENTION

One aspect of the present disclosure is directed to a turbocharger for an engine. The turbocharger comprises a turbine and a housing. The housing may enclose the turbine and have a first annular passageway and a second annular passageway. Both of the first and second annular passageways may extend to the turbine. A valve mechanism may be disposed within an inlet of the housing and may have a valve element pivotally attached to a portion of the housing. The valve element may be movable between a first position blocking exhaust flow through the first annular passageway and a second position permitting exhaust flow through both of the first and second annular passageways. The turbocharger may also include a controller controlling positioning of the valve element based on a sensed operational parameter of the engine, wherein the controller controls functions of the engine.

Another aspect is directed to an engine including the turbocharger.

A further aspect of the present disclosure is directed to a method of operating a turbocharger for an engine. The method may comprise directing an exhaust flow through a first annular passageway and a second annular passageway in a housing from an inlet to a turbine. A valve element pivotally attached to a portion of the housing may be selectively moved between a first position blocking exhaust flow through the first annular passageway and a second position permitting exhaust flows through both of the first and second annular passageways. The method may further include controlling, via a controller, positioning of the valve element based on a sensed operational parameter of the engine, and also include controlling functions of the engine via the controller.

Yet another aspect is directed to a method of operating an engine, including compressing air in accordance with the method of operating a turbocharger.

### BRIEF DESCRIPTION OF THE DRAWINGS

FIG. 1 is a diagrammatic illustration of an exemplary disclosed engine;

FIG. 2; is a cross-sectional view illustration of an exemplary disclosed turbocharger for the engine of FIG. 1;

FIG. 3 is an exploded view illustration of the turbocharger of FIG. 2;

FIG. 4 diagrammatically illustrates an exemplary engine cylinder and related engine components for the engine of FIG. 1;

FIG. 5 is a graph illustrating an exemplary intake valve operation as a function of engine crank angle in accordance with the present disclosure; and

FIG. 6 is a diagrammatic view of an exemplary engine including plural turbochargers.

### DETAILED DESCRIPTION

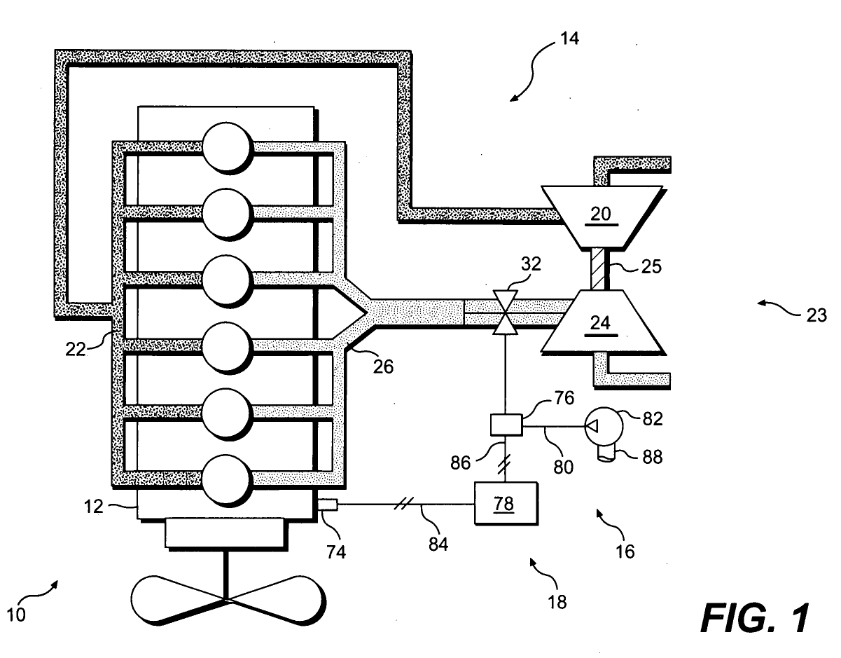

FIG. 1 illustrates an exemplary engine 10, which may be, for example, a diesel engine, a gasoline engine, a natural gas engine, or any other engine apparent to one skilled in the art. For example, engine 10 may be a compression ignited engine, such as a diesel engine, and may be fueled by any fuel generally used in a compression ignited engine, such as diesel fuel. Alternatively, engine 10 may be of the spark ignited type and may be fueled by gasoline, natural gas, methane, propane, or any other fuel generally used in spark ignited engines. Engine 10 may be, for example, a four cycle (i.e., four-stroke) internal combustion engine, and may include multiple cylinders.

As discussed in more detail below, engine 10 may include at least one turbocharger 23 including a compressor 20 and a turbine 24. Engine 10 may receive intake air from an air induction system 14 associated with compressor 20 and expel combustion byproducts to an exhaust system 16 associated with turbine 24. Engine 10 may also include a control system 18 in communication with one or more portions of engine 10, such as, for example, exhaust system 16.

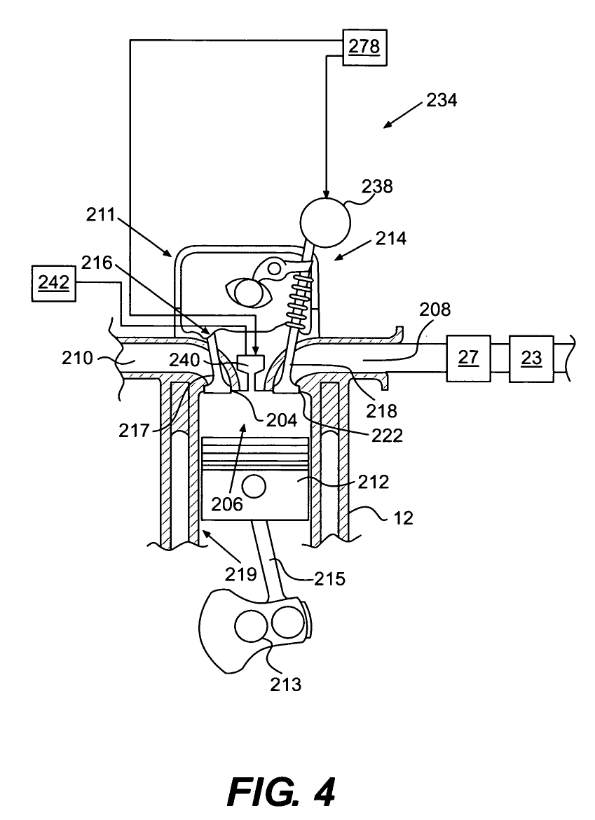

In the air induction system 14, compressor 20 may be fluidly connected to an intake manifold 22 to direct compressed air into the combustion chambers of engine 10. Compressor 20 may include a fixed geometry type compressor, a variable geometry type compressor, or any other type of compressor configuration known in the art. As explained below, more than one compressor 20 may be included and disposed in series or in parallel relationship. In addition, as shown in FIG. 4, at least one cooler 27 may be disposed downstream of each compressor associated with a turbocharger 23. It is contemplated that additional components may be included within air induction system 14 such as, for example, additional air coolers, throttle valves, air cleaners, and other components known in the art.

As schematically shown in FIG. 1, exhaust system 16 may be arranged so that turbine 24 of turbocharger 23 is fixedly connected to compressor 20 via a shaft 25. Hot exhaust gases may be directed away from the combustion chambers of engine 10 via an exhaust manifold 26 fluidly connected to turbine 24. The hot exhaust gases from engine 10 may expand against the blades (not shown) of turbine 24 and drive the rotation of the turbine 24 resulting in a corresponding rotation of compressor 20. It is contemplated that more than one turbine 24 may be included within exhaust system 16 and disposed in parallel or in series relationship. It is also contemplated that exhaust system 16 may include additional components such as, for example, exhaust filtering devices, exhaust treatment devices, exhaust gas recirculation components, and other components known in the art. Examples of some of such additional components are discussed below.

FIG. 4 diagrammatically illustrates certain operational details in connection with one cylinder of engine 10. The illustration in FIG. 4 and the following description may be representative of each of the cylinders of engine 10. Piston 212 may reciprocate within cylinder 219 mounted in engine block 12. Intake valve assembly 214 may be associated with cylinder head 211 and include an intake valve 218. A variable intake valve closing system 234 may include intake valve assembly 214 and a variable intake valve closing mechanism 238, controlled by a system controller 278. Under control of the variable intake valve closing system 234, intake valve 218 may selectively open to admit air and/or an air/fuel mixture to cylinder 219 through intake port 222, and may selectively close to capture air and/or an air/fuel mixture within cylinder 219. In addition, intake valve 218 may selectively open to admit a mixture of air and engine exhaust gases, or a mixture of air, fuel, and engine exhaust gases, and may selectively close to capture the mixture of air and engine exhaust gases, or the mixture of air, fuel, and engine exhaust gases, within cylinder 219.

Intake air and/or air/fuel mixture may flow toward intake port 222 and cylinder 219 via intake flow path 208 after having been compressed by at least one pre-compression unit, such as turbocharger 23, and then cooled by one or more cooling units, such as cooler 27. Similarly, a mixture of air and engine exhaust gases, or a mixture of air, fuel, and engine exhaust gases, may flow toward intake port 222 and cylinder 219 via intake flow path 208 after having been compressed by at least one pre-compression unit, such as turbocharger 23, and then cooled by one or more cooling units, such as cooler 27. Thus, cooled, pressurized air, or a mixture of cooled, pressurized air and fuel, or a mixture of cooled, pressurized air and engine exhaust gases, or a mixture of cooled, pressurized air, fuel, and engine exhaust gases, may enter a combustion chamber 206 partially defined by piston 212. Once combustion has occurred within combustion chamber 206, exhaust valve 217 of exhaust valve assembly 216 may selectively open to permit the exhaust flow of gases from combustion chamber 206 through exhaust port 204 and into exhaust flow path 210, and may selectively close to inhibit the flow of gases through exhaust port 204. A suitable fuel may be admitted to combustion chamber 206. For example, in lieu of or in addition to any fuel that may be supplied to combustion chamber 206 along with intake air, fuel may be delivered directly to combustion chamber 206 via a fuel injector assembly 240 provided with fuel from a suitably fuel supply 242.

Summarizing, restating, and expanding on the description thus far, engine 10 may be a four-stroke, internal combustion engine including at least one combustion chamber 206 with at least one intake port 222 associated therewith. Piston 212 may partially define the chamber 206 and be movable in a reciprocating manner within a cylinder 219 through a plurality of power cycles. Each power cycle may involve four strokes of the piston 212 resulting from two rotations of a crankshaft 213 driving connecting rod 215. The four strokes may include an intake stroke, a compression stroke, an expansion stroke (also known as a combustion stroke or a working stroke), and an exhaust stroke. Each power cycle may be aided by combustion taking place within the chamber 206.

Air may be compressed and cooled outside the chamber 206, for example by turbocharger 23 and cooler 27. Cooled, pressurized air may be supplied to the at least one intake port 222 associated with the chamber 206. At the end portion of the exhaust stroke, or at the beginning portion of the intake stroke, the at least one intake port 222 may be opened, thereby allowing cooled, pressurized air to flow through the at least one intake port 222 and into the chamber 206 during at least a portion of the intake stroke. During at least some power cycles, the at least one intake port 222 may be maintained open during the portion of the intake stroke and beyond the end of the intake stroke and into the compression stroke and during a majority portion of the compression stroke.

The term “majority portion of the compression stroke” is a term associated with Miller Cycle engine operation. A particular characteristic of the Miller Cycle is that the intake valve closes either early during the intake stroke, or late during the compression stroke. The term “majority portion of the compression stroke” refers particularly to a variety of late intake valve closing Miller Cycle in which the intake valve closes after remaining open for more than 90 crank angle degrees of the total 180 crank angle degrees in the compression stroke. In other words, the intake valve closing after a “majority portion of the compression stroke” refers to the intake valve closing after piston 212 travels through more than half of the compression stroke.

To further explain the term “majority portion of the compression stroke,” it is important to note that the beginning of the compression stroke is when the piston 212 is at its bottom dead center (BDC) position, after the piston 212 has completed its entire intake stroke. Piston 212 travels through a “majority portion of the compression stroke” when the crankshaft 213 rotates more than 90° after bottom dead center (greater than 90° ABDC) of the compression stroke. When the at least one intake port 222 is maintained open into the compression stroke and during a “majority portion of the compression stroke,” intake valve 218 does not close intake port 222 until more than 90° ABDC.

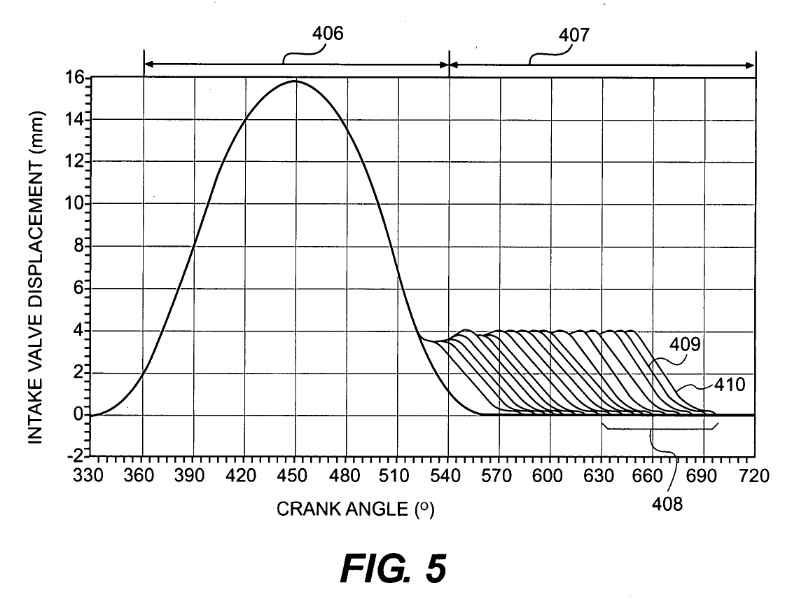

FIG. 5 graphically illustrates intake valve timing in accordance with exemplary disclosed embodiments. In connection with FIG. 5, it should be understood that 720 degrees represent two complete rotations of crankshaft 213 occurring during each four-stroke power cycle and that 0 degrees (not shown in FIG. 5) constitutes the beginning of the expansion stroke. Intake valve 218 (see FIG. 4) may begin to open at about 360° crank angle, that is, when the crankshaft 213 is at or near a top dead center (TDC) position of an intake stroke 406. The closing of the intake valve 218 may be selectively varied so as to close the intake port 222 at any crank angle position 407 in the compression stroke, ranging from BDC of the compression stroke (540° in FIG. 5) to TDC of the compression stroke (720° in FIG. 5). FIG. 5 graphically illustrates various intake valve closing positions at 408, representing the intake valve 218 remaining open for a majority portion of compression stroke 407. Each of the intake valve displacement profiles associated with the valve closing positions 408 show the intake valve 218 held open for a majority portion of the compression stroke 407, that is, for the first half of the compression stroke 407 (in FIG. 5, from 540° to 630°) and a portion of the second half of the compression stroke 407 (in FIG. 5, greater than 630°).

After the at least one intake port 222 is maintained open, the at least one intake port 222 may be closed at some time during travel of the piston 212 to capture in the chamber 206 a cooled compressed charge comprising the cooled, pressurized air (and any fuel and/or recirculated exhaust gas introduced into the chamber 206 along with the air). Fuel may be controllably delivered into the chamber 206 after the cooled compressed air is captured within the chamber 206, and the fuel and air mixture may be ignited within the chamber 206. While fuel may be delivered to chamber 206 directly via fuel injector unit 240, it will be understood that fuel may be mixed with the intake air at some point outside chamber 206, e.g., upstream of turbocharger 23 so as to form a fuel/air mixture that may be compressed within turbocharger 23 and subsequently cooled by cooler 27 before entering chamber 206.

The variable intake valve closing system 234 may close the intake valve 218 at a first crank angle during one four stroke cycle of the piston 212, and at a second crank angle during another four stroke cycle of the piston 212, with the first crank angle being different from the second crank angle. Both the first crank angle and the second crank angle may occur after a majority portion of the compression stroke has occurred. For example, referring to FIG. 5, the closing crank angle represented by alternative curves 409 and 410 both occur after a majority portion of the compression stroke. In one example, during a given plurality of four stroke cycles, intake valve 218 (FIG. 4) may close along curve 409 in one cycle, and close along curve 410 in a succeeding cycle. The variable intake valve closing system 234 may permit delaying or retarding the closing of intake valve 218 to any extent into the compression stroke. For example, in one exemplary embodiment, the intake valve 218, and thus intake port 222, may be maintained open for at least 65% of the compression stroke (which is about 117° ABDC of the compression stroke). In other exemplary embodiments, the intake valve 218 and intake port 222 may be maintained open for at least 80% or 85% of the compression stroke (which is about 144° or 153° ABDC of the compression stroke). Maintaining the intake port 222 open for a majority portion of the compression stroke may occur, for example, during high load operation of the engine 10.

Overall system controller 278 may be configured to control operation of the variable intake valve closing mechanism 238 and/or fuel injector assembly 240 based on one or more engine conditions, such as, engine speed, load, pressure, and/or temperature in order to achieve a desired engine performance. The controller 278 may be in the form of a single controlling unit or a plurality of units. In some examples, controller 278 shown in FIG. 4 and controller 78 shown in FIG. 1 may be combined into a single controlling unit (e.g., rather than having separate controller 78 and 278, the engine may have a single controller configured to perform all of the controlling performed by each of the controllers 78 and 278) and/or may be in communication with one another so as to receive at least some common input and/or to provide at least some common output. Where the engine is a natural gas or gasoline engine, spark timing may be controlled by controller 278 in a fashion similar to fuel injector timing of a compression ignition engine.

Controllable delivery of fuel into the chamber 206 via fuel injector assembly 240 may include injecting a pilot injection of fuel and injecting a main injection of fuel. The pilot injection of fuel may commence when the crankshaft 213 is at about 675 crank angle degrees, that is, about 45° BTDC of the compression stroke. The main injection of fuel may begin about 35° to 45° after commencement of the pilot injection. Generally, the pilot injection may commence when the crankshaft 213 is about 40° to 50° BTDC of the compression stroke and may last for about 10-15 degrees of crankshaft rotation. The main injection may commence when the crankshaft 213 is between about 10° BTDC of the compression stroke (i.e., about 710 crank angle degrees) and about 12° ATDC of the expansion stroke. The main injection may last for about 20-45 crank angle degrees of rotation. The portion of fuel injected in the pilot injection may be about 10% of the total fuel injected in both the pilot and main injections.

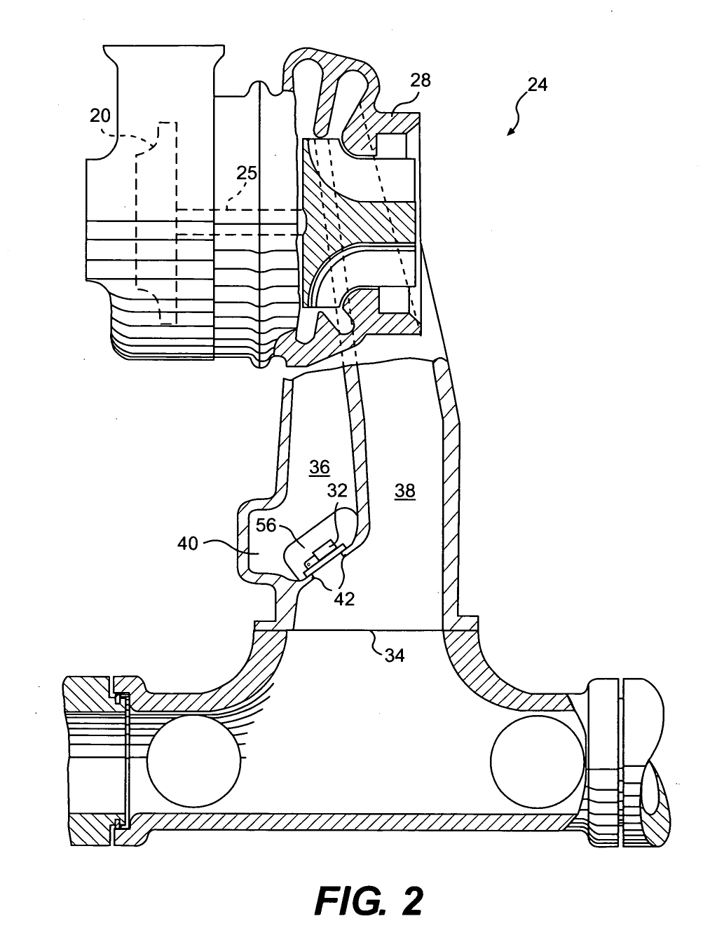

As illustrated in FIG. 2, turbocharger 23 may include a divided turbine housing 28 and a valve assembly 32. Divided turbine housing 28 may have an inlet 34, two annular passageways 36 and 38 that extend from inlet 34 to turbine 24, a recess 40 disposed within an outer wall of divided turbine housing 28, and a valve seat 42 configured to receive valve assembly 32. Exhaust gases from the combustion chambers of engine 10 may be directed from exhaust manifold 26 to turbine 24 by way of annular passageways 36 and 38. Annular passageway 36 may be selectively blocked by valve assembly 32, thereby directing all of the exhaust flow through annular passageway 38. Valve assembly 32 may be shielded from the exhaust gases when moved to the flow passing position within recess 40.

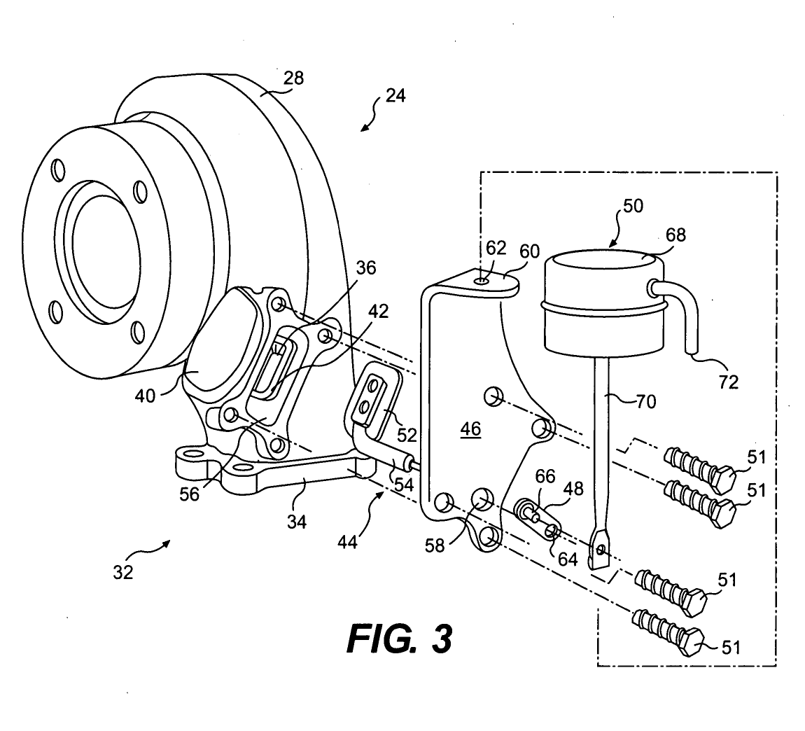

As illustrated in FIG. 3, valve assembly 32 may include numerous components that function together to selectively block annular passageway 36. In particular, valve assembly 32 may include a valve element 44, a cover plate 46, a connecting member 48, and an actuator 50. One or more fasteners 51 may be implemented to retain the components of valve assembly 32.

Valve element 44 may include a generally planar member 52 having a substantially square shape and being fixedly connected to a pivot shaft 54 that is distally located from a central portion of planar member 52. It is contemplated that valve element 44 may, alternatively, have a shape other than square such as rectangular, square, or any other appropriate shape. Planar member 52 may be pivoted via pivot shaft 54 between a flow passing position where planar member 52 is received within recess 40 and shielded from exhaust flow, and against a flow of exhaust toward a flow blocking position where planar member 52 mates against valve seat 42. The term blocked, for the purposes of this disclosure, is to be interpreted as at least partially restricted from air flow. It is contemplated that valve element 44, when in the flow blocking position, may fully restricted air flow through annular passageway 36.

Cover plate 46 may provide external access to valve element 44 while turbocharger 23 is assembled to the remainder of engine 10. In particular, divided turbine housing 28 may include an opening 56 providing access to valve element 44. Cover plate 46 may be removably attachable to divided turbine housing 28 to close off opening 56 during operation of turbocharger 23. It is contemplated that a seal such as, for example, a gasket (not shown) may be disposed between cover plate 46 and divided turbine housing 28 to minimize leakage from opening 56. Cover plate 46 may include a bore 58 through which pivot shaft 54 extends, and a support shelf 60 having a bore 62 for mounting actuator 50.

Connecting member 48 may include a bore 64 attachable to pivot shaft 54 and a pin 66 attachable to actuator 50. Because the axis of bore 64 and pin 66 are radially offset from each other, a linear motion of actuator 50 may be converted into a pivoting movement of valve element 44. Connecting member 48 may be assembled to pivot shaft 54 between cover plate 46 and actuator 50.

Actuator 50 may be pneumatically operated to initiate movement of valve element 44. Specifically, actuator 50 may include a spring-biased piston member (not shown) disposed within a pressure chamber 68 and fixedly connected to a piston rod 70. Pressurized air directed into pressure chamber 68 via an inlet 72 may urge the spring-biased piston member from a first position downward away from pressure chamber 68. Conversely, allowing the pressurized air to drain from pressure chamber 68 may allow the spring-biased piston member to return to the first position.

Control system 18 (referring to FIG. 1) may include components that function to regulate air flow to actuator 50 in response to one or more operational parameters of engine 10. In particular, control system 18 may include a sensor 74, a solenoid valve 76 disposed within an air passageway 80 between a source 82 of pressurized air and actuator 50 of valve assembly 32, and controller 78. Controller 78 may be in communication with sensor 74 via a communication line 84 and with solenoid valve 76 via a communication line 86.

Sensor 74 may be associated with engine 10 to sense an operational parameter of engine 10 and to generate a signal indicative of the parameter. These operational parameters may include, for example, a load and/or a speed of engine 10. The load of engine 10 may be sensed by monitoring a fuel setting of engine 10, by sensing a torque and speed output of engine 10, by monitoring a timing of engine 10, by sensing a temperature of engine 10, or in any other manner known in the art. A speed of engine 10 may be sensed directly with a magnetic pick-up type sensor disposed on an output member of engine 10, or in any other suitable manner. It is contemplated that other operational parameters may alternatively or additionally be sensed by sensor 74 and communicated to controller 78 such as, for example, boost pressure, turbine speed, and other parameters known in the art.

Solenoid valve 76 may include a spring-biased valve element that is movable between a first position and a second position in response to an electronic signal from controller 78. When in the first position, pressurized air from source 82 may be communicated with pressure chamber 68 to cause piston rod 70 to extend relative to pressure chamber 68. When in the second position, the pressurized air from within pressure chamber 68 may be allowed to drain to the atmosphere, causing piston rod 70 to return to the retracted position relative to pressure chamber 68.

Controller 78 may be configured to receive the signal from sensor 74 and to selectively energize solenoid valve 76 in response to the signal. For example, the signal from sensor 74 may indicate that engine 10 is operating under low load and speed conditions where additional boost might be beneficial. In order to increase the boost provided to engine 10, controller 78 may cause solenoid valve 76 to move to the second position, thereby retracting piston rod 70 and causing valve element 44 to block annular passageway 36. Conversely, if the signal from sensor 74 indicates that engine 10 is operating under high load and speed conditions where excessive boost may cause the rotational speed of turbine 24 to exceed a maximum allowable speed, controller 78 may cause solenoid valve 76 to move to the first position, thereby extending piston rod 70 and causing valve element 44 to move to the flow passing position within recess 40.

Controller 78 may be embodied in a single microprocessor or multiple microprocessors configured to control an operation of turbocharger 23. Numerous commercially available microprocessors can be configured to perform the functions of controller 78. It should be appreciated that controller 78 could readily be embodied in a general power system microprocessor capable of controlling numerous power system functions. Controller 78 may include a memory, a secondary storage device, a processor, and any other components for running an application. Various other circuits may be associated with controller 78 such as power supply circuitry, signal conditioning circuitry, solenoid driver circuitry, and other types of circuitry.

Source 82 may be configured to produce a flow of pressurized air and may include a dedicated compressor such as, for example, a variable displacement compressor, a fixed displacement compressor, or any other source of pressurized air known in the art. Source 82 may be drivably connected to engine 10 by, for example, a countershaft 88, a belt (not shown), an electrical circuit (not shown), or in any other suitable manner. Alternatively, source 82 may be indirectly connected to the remainder of engine 10 via a torque converter, a gear box, or in any other appropriate manner. It is contemplated that multiple sources of pressurized air may be interconnected to supply pressurized fluid to control system 18. It is also contemplated that a source 82 may be omitted, if desired, and the pressurized air directed from compressor 20 to actuator 50 via solenoid valve 76.

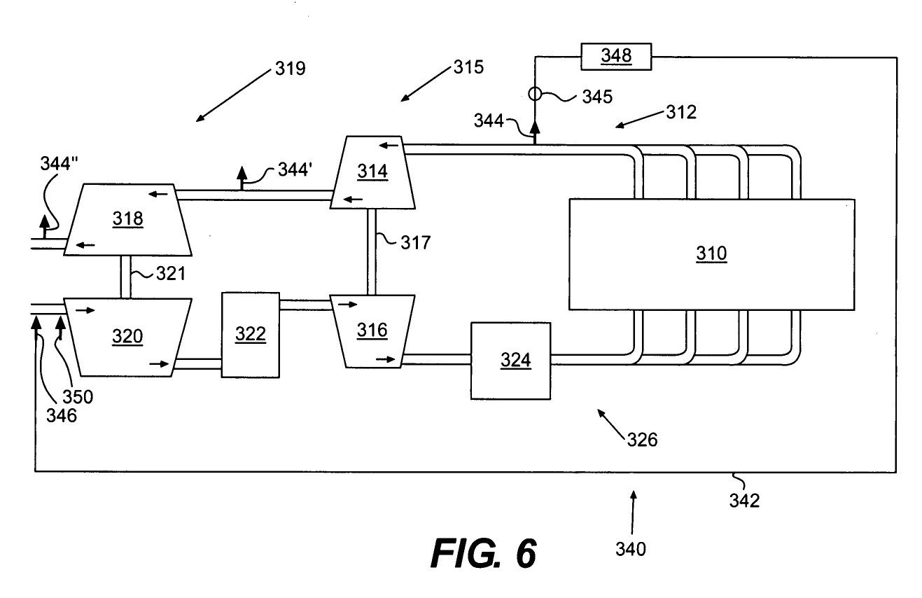

FIG. 6 illustrates an exemplary embodiment of an engine 310 similar to engine 10 of FIG. 1 and having one or more engine cylinders and other components configured as shown in FIG. 4 and operating in accordance with the above discussion relating to FIG. 4. Engine 310 shown in FIG. 6 includes multiple stages of pressurization of engine intake air, provided, for example by plural turbochargers 315 and 319. One or more (e.g., all) of the turbochargers 315 and 319 may have substantially the same configuration as the turbocharger 23 shown in FIG. 1.

During operation of engine 310, exhaust gases may flow through exhaust system 312, first to a turbine 314 of a turbocharger 315 and then to a turbine 318 of a turbocharger 319. Intake air and or air/fuel mixture may flow through intake system 326, passing first through compressor 320 of turbocharger 319 and thereafter through compressor 316 of turbocharger 315. Compressor 316 may be driven by turbine 314 via shaft 317, while compressor 320 may be driven by turbine 318 via shaft 321. A cooling unit in the form of intercooler 322 may be positioned between compressor 320 and compressor 316 to cool air and/or air/fuel mixture pressurized by compressor 320 and thereby increase its density. A cooling unit in the form of aftercooler 324 may be positioned between compressor 316 and the intake ports of engine 310 to cool air and/or air/fuel mixture pressurized by compressor 316 and further increase the density of the air and/or fuel/air mixture.

Compressor 320 may compress intake air from ambient atmospheric pressure to approximately 2-3 atmospheres, for example. In doing so, the air may be heated from an ambient temperature of, for example, 68° F. up to approximately 313° F. Intercooler 322 may then cool the air to approximately 140° F. and increase its density. The compressed and cooled air may then enter compressor 316 and be compressed further to approximately 4-6 atmospheres, for example. After compression within compressor 316 raises temperature of the intake air once again, aftercooler 324 may reduce the temperature of the intake air to less than or equal to 200° F. Thus, intake air may be pressurized to at least 5 atmospheres, or even 6 atmospheres, and cooled to as low as 200° F. or below so as to produce pressurized air or a pressurized mixture of fuel and air which is subsequently captured within the combustion chambers in engine 310.

Referring still to the exemplary embodiment diagrammatically illustrated in FIG. 6, emissions control and fuel efficiency may be enhanced by employing various expedients. For example, a system for controllably recirculating a portion of the engine exhaust gases may be employed. While such a system may be recognized by different designations in the art, for purposes of simplifying this description, the term EGR (exhaust gas recirculation) will be employed. EGR system 340 may be configured to extract a portion of the engine exhaust gases from exhaust system 312, before conveying the exhaust gases through a suitable flowpath 342, and introducing the exhaust gases into the intake system 326.

In the exemplary embodiment of FIG. 6, exhaust gases may be extracted from exhaust system 312 at a relatively high pressure point, designated by arrow 344, between exhaust ports of engine 310 and turbine 314, and introduced into the intake system at a relatively low pressure point, designated by arrow 346, upstream of compressor 320, resulting in a mixture in intake system 326 including air and recirculated exhaust gases. In such an arrangement, the turbochargers 319 and 315 compress the air and exhaust gas mixture and the intercooler 322 and aftercooler 324 cool the air and exhaust gas mixture before the cooled, compressed mixture is supplied to the combustion chamber of the engine 310 via an intake por(s)t. Extraction of exhaust gases may alternatively occur at other points in the exhaust system 312, such as the points indicated by arrows 344′ (between the two turbochargers) and 344″ (downstream of turbine 318).

Such a system, wherein exhaust gases to be recirculated in an EGR system are introduced at a relatively low pressure point upstream of any precompression of intake air, is sometimes referred to in the art as a “low pressure” EGR system. A suitable flow control device 345 (e.g., valve) may be provided to control the amount of exhaust gases extracted from exhaust system 312 and, thereby, vary the proportion of exhaust gas and air in the mixture that is compressed and cooled before introduction in the combustion chamber of engine 310. Flow control device 345 may be controlled by a suitable controller (e.g., controller 278 shown in FIG. 4 and/or controller 78 shown in FIG. 1) in response to a monitored condition such as engine load or engine speed, for example. Subsequent to extraction of exhaust gases at point 344 and before introduction into intake system 326 at point 346, the hot exhaust gases may be cooled by a cooler 348. One disclosure of a prior art system involving extraction of exhaust gases from an exhaust system and introduction of the exhaust gases into an air intake system upstream of two stages of compression (low pressure EGR) is described in U.S. Pat. No. 5,617,726 issued to Sheridan et al. The Sheridan et al. patent illustrates, in FIGS. 5-7 thereof, different points of extraction of exhaust gases. The Sheridan et al. patent also discloses that the extracted exhaust gases may be passed through a cooler (19) before being introduced into the intake system for the engine (1). Additionally, after passing through two stages of pressurization (8, 6), the air and exhaust gas mixture passes through a cooler (17) in Sheridan et al.

Referring still to FIG. 6, another expedient that may be employed in engine 310 is represented diagrammatically by the arrow 350. Similar to the above discussion in connection with FIG. 4, fuel may be admitted to the combustion chambers of engine 310 via one or more injectors (such as fuel injector assembly 240 in FIG. 4) situated so as to inject fuel directly into the combustion chamber. Alternative, or additionally, fuel may be introduced into intake system 326 at a point upstream of one or more of compressors 316 or 320. For example, fuel may be introduced upstream of compressor 320 at the point designated diagrammatically by arrow 350. As exemplified by the embodiment illustrated in FIG. 6, the expedient of introducing fuel upstream of precompression of the intake air may be employed in combination with the expedient of low pressure EGR, previously discussed. One prior art disclosure of both the introduction of fuel upstream of a compressor for intake air and the use of low pressure EGR is U.S. Pat. No. 5,357,936 to Hitomi et al. The Hitomi et al. patent illustrates (in FIG. 3 of the patent) a fuel injector (56) upstream of the compressor (represented by supercharger (32)), and a low pressure EGR system including EGR cooler (72) and a point of introduction of the low pressure EGR upstream of supercharger (32).

### INDUSTRIAL APPLICABILITY

Fuel efficiency, emissions control, and power output may be effectively managed and balanced by employing the turbocharger 23 in an engine that also employs variable late closing Miller Cycle features along with low pressure EGR and multi-stage fuel injection and/or compressing and cooling a fuel/air mixture prior to capturing the fuel/air mixture in an engine cylinder. In one exemplary embodiment, fuel may be admitted or injected into the intake air upstream of one or more turbocharger compressors to form a fuel/air mixture which is pressurized and cooled to form a pressurized, temperature-controlled fuel/air mixture. This fuel/air mixture may then be introduced through an inlet port into the combustion chamber of an engine cylinder for combustion during one or more (e.g., each) four-stroke engine cycles, including four-stroke engine cycles such as those shown in FIG. 5 that involve an intake valve being open during a majority portion of the compression stroke and closing very late in the compression stroke.

As shown in connection with the exemplary embodiment of FIG. 6, exhaust gases may be controllably extracted from the exhaust system and introduced at a point upstream of one or more turbocharger compressors to form an air/exhaust gas mixture which is pressurized and cooled prior to being passed through an inlet port into the combustion chamber of an engine cylinder for combustion during one or more four-stroke engine cycles, including those involving the intake valve remaining open during a majority portion of the compression stroke and closing very late in the compression stroke.

Combining the disclosed turbocharger with the Miller Cycle related feature of maintaining open at least one intake valve during at least a portion of the intake stroke and beyond the end of the intake stroke and into the compression stroke and during a majority portion of the compression stroke, may enhance engine performance. Moreover, engine performance may be enhanced even further by the addition of one or more of variable intake valve closing, multi-stage fuel injection, dual stage turbocharging, pre-compression of an air/fuel mixture, and low pressure EGR. Additionally, while FIG. 6 illustrates two turbochargers employed to yield two stages of pressurization, it will be understood that more than two stages of pressurization are contemplated to be within the scope of this disclosure. For example, three stages of turbocharging and corresponding pressurization of intake air may offer even greater flexibility and control. One prior art example of the use of three stages of turbocharging is disclosed in U.S. Pat. No. 4,930,315 issued to Kanesaka. See, for example, FIG. 7 of the Kanesaka patent.

The disclosed turbocharger may be applicable to any engine where turbocharger efficiency and function throughout a range operational conditions is desired. Turbocharger 23 may provide adequate boost at low engine load and speed conditions and may minimize the likelihood of turbocharger speeds exceeding a maximum allowable speed at high load and speed conditions by selectively directing all of the exhaust flow from engine 10, 310 through only one or both of the two separated annular passageways 36 and 38.

In addition to providing adequate boost at low engine load and speed conditions and preventing turbine overspeed at high load and speed conditions, turbocharger 23 may provide additional advantages. In particular, because valve element 44 closes against valve seat 42, a greater amount of exhaust may be blocked from flowing through annular passageway 36 than if valve seat 42 were omitted. The increased amount of blockage may improve turbine efficiency and boost at low load and speed conditions. In addition, because valve element 44 has a square cross shape, the opening, which valve element 44 selectively closes off to block annular passageway 36, may also be square, providing increased flow area with minimal restriction, as compared to a valve element having a circular shape. Further, because valve element 44 is pivoted against a flow of exhaust when moving toward the flow blocking position and with the flow of exhaust when moving toward the flow passing position, it may be relatively easy to unseat valve element 44. In addition, because valve element 44 is shielded from exhaust flow within recess 40 when moved toward the flow passing position, valve element 44 may have increased component life and further reduce restriction within turbocharger 23, as compared to a valve element that always remains within the flow of exhaust.

It will be apparent to those skilled in the art that various modifications and variations can be made to the subject matter of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A turbocharger for an engine, the turbocharger comprising:
a turbine;
a housing enclosing the turbine and having a first annular passageway and a second annular passageway, both of the first and second annular passageways extending to the turbine;
a valve mechanism disposed within an inlet of the housing and having a valve element pivotally attached to a portion of the housing, the valve element being movable between a first position blocking exhaust flow through the first annular passageway and a second position permitting exhaust flow through both of the first and second annular passageways; and
a controller controlling positioning of the valve element based on a sensed operational parameter of the engine,
wherein the controller controls functions of the engine.

2. The turbocharger of claim 1, wherein the housing further includes a recess configured to receive the valve element when the valve element is in the second position, the recess shielding the valve element from at least a portion of the exhaust flow when the valve element is in the second position.

3. The turbocharger of claim 1, wherein the controller controls movement of the valve element to the second position based on sensed high speed and high load conditions of the engine.

4. An engine comprising:
the turbocharger of claim 1;
a chamber with an intake port associated therewith;
a piston partially defining the chamber and being movable in a reciprocating manner within a cylinder through cycles, each cycle involving four strokes of the piston and two rotations of a crankshaft, the four strokes including an intake stroke, a compression stroke, an expansion stroke, and an exhaust stroke;
a cooler cooling air compressed by the turbocharger and supplying the cooled, pressurized air to the intake port associated with the chamber; and
an intake valve movable to open and close the intake port;
wherein the engine is configured so that the intake valve
opens the intake port,
allows cooled, pressurized air to flow through the intake port and into the chamber during the intake stroke,
maintains open the intake port during the intake stroke and beyond the end of the intake stroke and into the compression stroke and during a majority portion of the compression stroke, and
then closes the intake port during travel of the piston to capture in the chamber a cooled, compressed charge comprising the cooled pressurized air.

5. The engine of claim 4, further including a fuel delivery system delivering fuel into the chamber after the cooled compressed charge is captured in the chamber, wherein the engine ignites a mixture of the fuel and air within the chamber.

6. The engine of claim 5, wherein the fuel delivery system supplies pressurized fuel directly to the chamber during a portion of the compression stroke and during a portion of the expansion stroke.

7. The engine of claim 4, further including an exhaust gas recirculation system forming a mixture including air and recirculated exhaust gas, wherein the turbocharger compresses the air and exhaust gas mixture and the cooler cools the air and exhaust gas mixture before supplying the cooled, compressed mixture to the chamber via the intake port.

8. The engine of claim 7, wherein the exhaust gas recirculation system varies the proportion of exhaust gas and air in the mixture in response to at least one monitored condition and cools the recirculated exhaust gas prior to mixing the recirculated exhaust gas and the air.

9. The engine of claim 4, further including a variable intake valve closing system varying timing of the intake valve.

10. The engine of claim 9, wherein the variable intake valve closing system closes the intake valve at a first crank angle during one four stroke cycle of the piston and at a second crank angle during another four stroke cycle of the piston, the first crank angle being different from the second crank angle.

11. The engine of claim 4, wherein the intake port is maintained open for at least 65% of the compression stroke.

12. The engine of claim 4, wherein the intake port is maintained open for at least 80% of the compression stroke.

13. The engine of claim 4, wherein the turbocharger provides a first stage of compression for air and the cooler provides a first stage of cooling, and wherein the engine includes a second stage of compression and a second stage of cooling.

14. The engine of claim 4, wherein the air is compressed outside the chamber to at least 5 atmospheres, and then cooled to a temperature less than or equal to 200 degrees F.

15. The engine of claim 4, wherein the engine is a diesel-fueled, compression ignition engine.

16. The engine of claim 4, wherein the engine is either a gasoline-fueled engine or a natural gas-fueled engine, and wherein the engine is spark ignited.

17. The engine of claim 4, wherein the intake port is maintained open for a majority portion of the compression stroke during high load operation of the engine.

18. A method of operating a turbocharger for an engine, comprising:
directing an exhaust flow through a first annular passageway and a second annular passageway in a housing from an inlet to a turbine;
selectively moving a valve element pivotally attached to a portion of the housing between a first position blocking exhaust flow through the first annular passageway and a second position permitting exhaust flows through both of the first and second annular passageways;
controlling, via a controller, positioning of the valve element based on a sensed operational parameter of the engine; and
controlling functions of the engine via the controller.

19. A method of operating a four-stroke, internal combustion engine including a chamber with an intake port associated therewith, and a piston partially defining the chamber and being movable in a reciprocating manner within a cylinder through cycles, each cycle involving four strokes of the piston and two rotations of a crankshaft, the four strokes including an intake stroke, a compression stroke, an expansion stroke, and an exhaust stroke, the method comprising:
compressing air outside the chamber by operating a turbocharger in accordance with the method of claim 18;
cooling air outside the chamber;
supplying the cooled, pressurized air to the intake port associated with the chamber;
opening the intake port;
allowing cooled, pressurized air to flow through the intake port and into the chamber during the intake stroke;
maintaining open the intake port during the intake stroke and beyond the end of the intake stroke and into the compression stroke and during a majority portion of the compression stroke; and
after the maintaining, closing the intake port during travel of the piston to capture in the chamber a cooled, compressed charge comprising the cooled pressurized air.

20. The method of claim 19, further including delivering fuel into the chamber after the cooled compressed charge is captured in the chamber, and igniting a mixture of the fuel and air within the chamber.

21. The method of claim 20, further including supplying pressurized fuel directly to the chamber during a portion of the compression stroke and during a portion of the expansion stroke.

22. The method of claim 19, further including forming a mixture including air and recirculated exhaust gas, and compressing and cooling the air and exhaust gas mixture before supplying the cooled, compressed mixture to the chamber via the intake port.

23. The method of claim 22, further including varying the proportion of exhaust gas and air in the mixture in response to at least one monitored condition and cooling the recirculated exhaust gas prior to mixing the recirculated exhaust gas and the air.

24. The method of claim 19, further including varying timing of the intake valve.

25. The method of claim 24 wherein varying the timing includes closing the intake valve at a first crank angle during one four stroke cycle of the piston and at a second crank angle during another four stroke cycle of the piston, the first crank angle being different from the second crank angle.

26. The method of claim 19, wherein the intake port is maintained open for at least 65% of the compression stroke.

27. The method of claim 19, wherein the intake port is maintained open for at least 80% of the compression stroke.

28. The method of claim 19, wherein the compressing includes a first stage of pressurization and a second stage of pressurization, and wherein the cooling includes a first stage of cooling and a second stage of cooling.

29. The method of claim 19, wherein the air is compressed outside the chamber to at least 5 atmospheres, and then cooled to a temperature less than or equal to 200 degrees F.

30. The method of claim 19, wherein the engine is a diesel-fueled, compression ignition engine.

31. The method of claim 19, wherein the engine is either a gasoline-fueled engine or a natural gas-fueled engine, and wherein the engine is spark ignited.

32. The method of claim 19, wherein the intake port is maintained open for a majority portion of the compression stroke during high load operation of the engine.
